(19) United States
(12) Patent Application Publication
(10) Pub. No.: US 2012/0266250 A1
(43) Pub. Date: Oct. 18, 2012

(54) Selective Masking Of Identity-Indicating Information In Messages For An Online Community

(76) Inventor: Steven Blake Uhl, Los Gatos, CA (US)

(21) Appl. No.: 13/208,759

(22) Filed: Aug. 12, 2011

Related U.S. Application Data
(60) Provisional application No. 61/475,158, filed on Apr. 13, 2011.

(51) Int. Cl. G06F 21/24; G06F 15/16

(52) U.S. Cl. 726/26

(57) ABSTRACT

A method and apparatus is described for protecting a user's identity by automatically replacing all identity-indicating information in messages with aliases. Users may input real name/alias pairs into a web form to be stored in a database. Any content that USER-A posts will appear unmodified to users to which USER-A has granted permission. When a user who has not been granted permission views USER-A's content, the user will see a modified version of the content. In this case, any and all instances of USER-A's stored real names in USER-A's content will be replaced with USER-A's corresponding aliases.

### BENEFIT CLAIM

This application claims the benefit of Provisional Appln. 61/475,158, filed Apr. 13, 2011, the entire contents of which is hereby incorporated by reference as if fully set forth herein, under 35 U.S.C. §119(e).

### FIELD OF THE INVENTION

The present invention relates to establishing anonymous and/or pseudonymous communications between two or more parties via a computer terminal or mobile device. More specifically, the invention relates to selectively masking identity-indicating information of at least one of the parties to facilitate open sharing of confidential or sensitive information in a public online forum while protecting users' privacy.

### BACKGROUND

Asynchronous communication has long existed on the Internet, e.g., in the form of newsgroups, forums, and, more recently, social network services (collectively referred to herein as “online communities”). These online communities allow users to communicate their thoughts, feelings, experiences, and actions almost instantaneously to potentially countless other users.

When a user joins an online community they are prompted to create a profile and add other users to their network. In certain implementations, mutual confirmation is required from both parties in order to form a connection (e.g., facebook.com, linkedin.com). Other implementations do not require mutual confirmation and allow users to “follow” other users (e.g., twitter.com). Typically, the user has existing real-world relationships or common interests and connections with the other users in their online network. While it is possible to use an alias or pseudonym for a username in lieu of a real name, this is discouraged or forbidden by many online communities in order to facilitate connecting with real-world friends, colleagues, family, etc. Typically, a user's online identity is an extension of their real-world identity and the link between the two may be clear even when a pseudonym is utilized for a username. Users may mitigate privacy concerns by either limiting the visibility of the users' messages to a certain subset of users, or simply refraining from posting any confidential or potentially embarrassing information in the online community.

While there are clear benefits of knowing the true identities of users in an online community, there are instances where a “shielded identity” is preferable or necessary to facilitate open disclosure and discussion of sensitive topics. Example areas in which users may benefit from concealing their identities include online self-help, online counseling, or online forums for relationship help/advice. In such areas, the disclosure of the identity of a user could cause embarrassment, stigma, and ostracism. In addition, due to the sensitive nature of topics discussed in such areas, users may be unwilling to discuss their experiences openly unless they could be confident that their identity would remain hidden. However, simply masking a user's real name with an alias or screen name may be insufficient for completely shielding one's identity. A user could inadvertently provide identity-indicating information in the body of their posts and communications even if they used a pseudonym as a username to mask their real name. While it would be possible for a user to carefully compose and review posts to avoid the inclusion of any identity-indicating information, this would require extra effort, additional time, and would prevent spontaneous, open communication.

Thus, there is a need for a system that allows users to communicate sensitive or confidential information openly in an online community without worrying about revealing identity-indicating information to other users.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

Accordingly, a system and method are herein described that address the problems caused by the limitations and disadvantages of the prior art. More specifically, embodiments of the invention allow for completely open disclosure of personally-identifying and/or confidential information in a public forum while protecting a user's identity through the automatic and selective masking of all identity-indicating information in a user's messages, yet retaining the high-level meaning and utility of the messages.

In one embodiment of the invention, users of the system may provide real name/alias pairs or mappings to be stored in a database and associated with a user account. Any content that USER-A posts will appear unmodified to USER-A when served to USER-A, e.g., via a web page or in a stand-alone application. USER-A's content will also appear unmodified to other users to which USER-A has granted permission. However, when USER-B (who has not been granted permission by USER-A) views USER-A's content, USER-B will see a modified version of the content. In this case, any and all instances of USER-A's stored real names in USER-A's content will be replaced with USER-A's corresponding aliases.

In another embodiment of the invention, a database of words, such as those contained in a standard dictionary, may be utilized by the system to assist a message's author by automatically highlighting words in the message that may potentially be identity-indicating. In one embodiment of the invention, these words are automatically replaced in the message with a default alias. In another embodiment of the invention, a content author inputs a custom alias quickly and easily, via a popup form, to be added to the real name/alias list for the content author that is stored in a database.

While the foregoing summary of the invention enables one of ordinary skill to make and use what is considered presently to be the best mode thereof, those skilled in the art will appreciate that the summary is illustrative only and is not intended to be in any way limiting. The operations disclosed herein may be implemented in a number of ways, and such changes and modifications may be made without departing from the embodiments of the invention and its broader aspects.

### BRIEF DESCRIPTION OF THE DRAWINGS

In the drawings:

FIG. 1 illustrates a simplified block diagram of a network configuration for allowing users to share confidential or personally-identifying information with others over a network without revealing their identity.

FIG. 2 illustrates an exemplary graphical user interface (“GUI”) in which a real name and alias for a user as well as a real name and alias for the user's partner can be submitted.

FIG. 3 illustrates an exemplary GUI in which a multitude of real name/alias pairs may be entered and associated with a user.

FIG. 4A illustrates an exemplary GUI in which a user may create a message and associate a multitude of real name/alias pairs with a user.

FIG. 4B illustrates an exemplary GUI in which a user may view a public preview of a message before submitting the message for publication.

FIG. 5A illustrates an exemplary Web browser that displays an on-line document that shows a list of user-generated messages from various users as if user “John” or user “Emily” were viewing the list.

FIG. 5B illustrates an exemplary Web browser that displays an on-line document that shows a list of user-generated messages from various users as if user “Jack” or user “Jill” were viewing the list.

FIG. 6A illustrates an exemplary mobile browser/app that displays a list of user-generated messages from various users as if user “John” or user “Emily” were viewing the list.

FIG. 6B illustrates an exemplary mobile browser/app that displays a list of user-generated messages from various users as if user “Jack” or user “Jill” were viewing the list.

FIG. 7 is a flow chart illustrating a process for associating real name/alias pairs to a user account.

FIG. 8 is a flow chart illustrating a process for posting a message, including associating real name/alias pairs to a user account, and previewing the public view of the message prior to posting the message.

FIG. 9 is a flow chart illustrating a process for displaying user-generated messages with identity-indicating words automatically replaced based on the corresponding user's stored real name/alias pairs.

FIG. 10 is a flow chart illustrating a process for selectively masking identity-indicating terms in user messages.

FIG. 11 is a block diagram of a computer system on which embodiments of the invention may be implemented.

### DETAILED DESCRIPTION

In the following description, for the purposes of explanation, numerous specific details are set forth in order to provide a thorough understanding of embodiments of the invention. It will be apparent, however, that embodiments of the invention may be practiced without these specific details. In other instances, well-known structures and devices are shown in block diagram form in order to avoid unnecessarily obscuring the embodiments of the invention.

### General Overview

Shielded identity of users in an online community allows users to freely and openly share their confidential and sensitive thoughts, feelings, and experiences without revealing their true identity. By associating various access levels to other members of the network, users may decide how much identity-indicating information to share with each other user. Also, by preserving the general high-level meaning of the message, a user is still able to communicate the user's situation to other members of the online community and receive helpful feedback from the other members. The following sets forth a detailed description of at least the best contemplated mode for carrying out the one or more devices and/or processes described herein. The description is intended to be illustrative and should not be taken to be limiting.

The description below emphasizes embodiments of the invention to shield a particular user's identity from other users of an online community by default, with the exception of those users that are explicitly granted permission to view the particular user's identity-indicating information. However, embodiments of the invention could also be implemented for users to share identity-indicating information by default and shield their identity only to certain users that are explicitly blocked. In addition, by utilizing the embodiments of the invention, it is also feasible to create multiple access levels and facilitate various amounts of shielding of identity depending on the user's permission level. However, for ease of explanation, only two access levels are discussed herein—one that allows viewing of all identity-indicating information, and one that allows viewing of no identity-indicating information.

### Identity-Indicating Term Masker Architecture

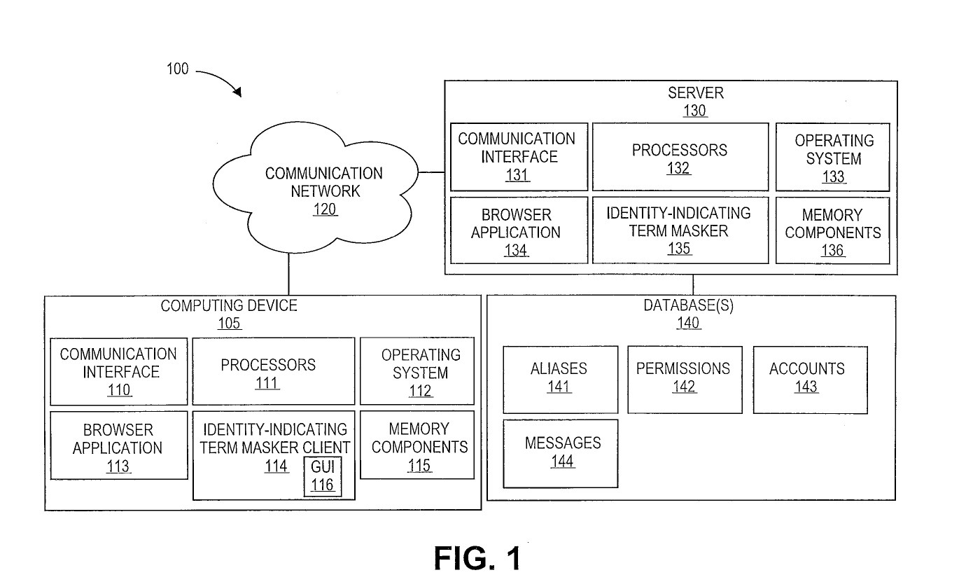

In one embodiment of the invention, an identity-indicating term masker includes a client component on a client device and a server-side component on a server device, which communicate over a network. FIG. 1 is a block diagram that depicts an example network arrangement 100 for selectively masking identity-indicating terms in user messages. Example network arrangement 100 includes a client computing device 105 and a server device 130, communicatively coupled via communication network 120. Server device 130 is also communicatively coupled to database 140.

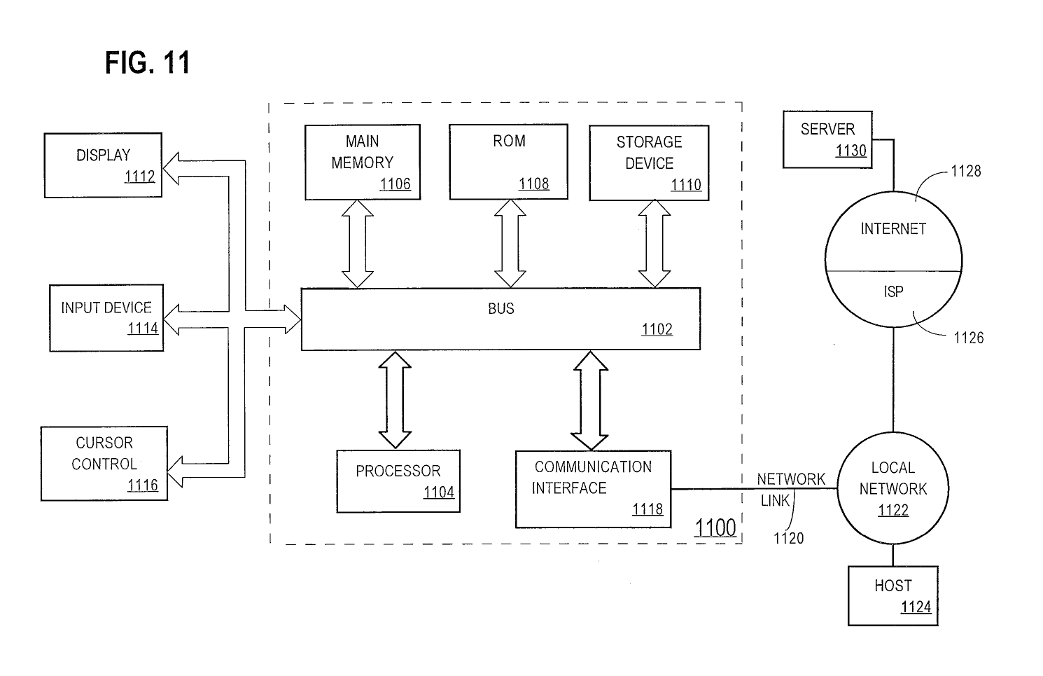

Client computing device 105 may be implemented by any type of client device. Example implementations of client computing device 105 include, without limitation, workstations, personal computers, laptop computers, personal electronic assistants (PDAs), telephony devices (e.g., a mobile “SmartPhone” such as, but not limited to, the Apple iPhone, the Droid phone, or the BlackBerry), televisions, personal media players, other computing devices, and any other type of device capable of hosting an identity-indicating term-masker client according to the embodiments of the invention. In example network arrangement 100, client computing device 105 is configured with a communication interface 110, processors 111, operating system 112, browser application 113, identity-indicating term-masker client 114 (referred to herein as “IITM client 114”), and memory components 115. Client computing device 105 may be configured without one or more of the components shown in example network arrangement 100. Client computing device 105 may also be configured with other mechanisms, processes, and functionality, depending upon a particular implementation. Further description of a computing device is provided in connection with FIG. 11.

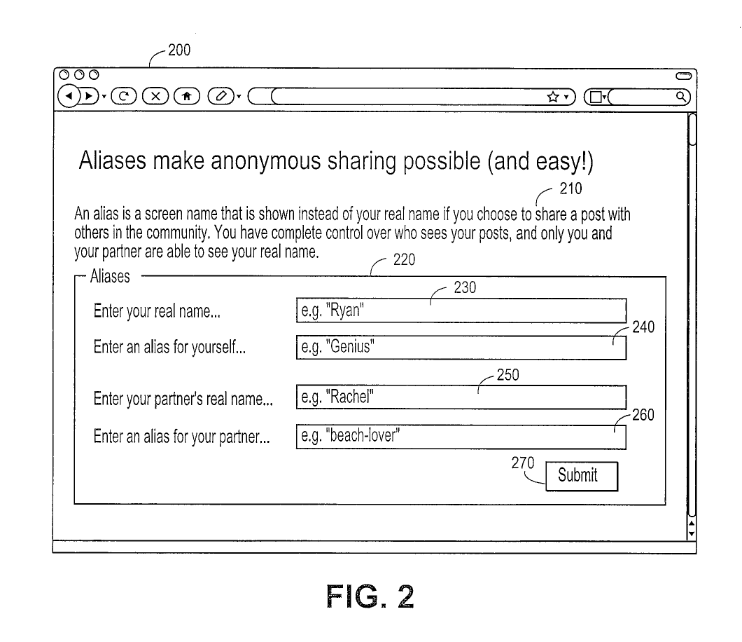

IITM client 114 may be implemented in any number of ways, including as a plug-in to browser application 113 (e.g., Javascript running in the user's browser), as a stand-alone application, in the hardware of client computing device 105, or as an application that runs on a website such as a portal site or a social networking site. In one embodiment of the invention, IITM client 114 is configured with a graphical user interface 116 (“GUI 116”), which may be displayed through a browser, in a stand-alone application, or using any other display mechanism. Through GUI 116, a user of a client computing device 105 may communicate with IITM client 114 and identity-indicating term masker 135 (“IITM 135”), described in further detail below. GUIs that are presented in FIGS. 2-6B are illustrative of embodiments of GUI 116, and are not meant to limit GUI 116 to any particular look or feel. A user of client computing device 105 may communicate with IITM client 114 and IITM 135 in alternate ways within the embodiments of the invention. Furthermore, IITM client 114 may perform any function attributed herein to IITM 135, and vice versa.

Example implementations of IITM client 114 include, without limitation, native software running on “SmartPhone” mobile devices such as the Apple iPhone, the Google Android-based phones, BlackBerry devices, Palm, Windows Mobile, and others. It also includes WAP (Wireless Application Protocol) interfaces, as well as traditional websites. Other implementations of IITM client 114 may include applications residing within social-networking websites such as Facebook and MySpace, applications residing on “portal” websites such as Yahoo (“Yahoo Apps”) and others, and web “widgets.”

Client computing device 105 is configured to communicate over communication network 120 with other devices, such as server device 130. Communication network 120 may be implemented with any type of medium and/or mechanism that facilitates the exchange of information between client computing device 105 and server device 130. Furthermore, communication network 120 may use any type of communications protocol, and may be secured or unsecured, depending upon the requirements of a particular application.

Server device 130 may be implemented by any type of device that is capable of communicating with client computing device 105 over communication network 120. In example network arrangement 100, server device 130 is configured with communication interface 131, processors 132, operating system 133, browser application 134, IITM 135, and memory components 136. Server device 130 may be configured without one or more of the components shown in example network arrangement 100. Server device 130 may also be configured with other mechanisms, processes and functionalities, depending upon a particular implementation.

IITM 135, as explained in even more detail below, is capable of masking identity-indicating terms in user messages for a user of client computing device 105. Aliases for identity-indicating terms may be received through IITM client 114, and IITM 135 uses that alias data to remove identity-indicating information from the user's messages in an online community. IITM 135 may be implemented in computer hardware, computer software, or any combination of computer hardware and software. As one non-limiting example, IITM 135 may be implemented as one or more software processes. IITM 135 may provide information to client computing device 105 in many forms within the embodiments of the invention. IITM 135 is configured to send and receive information over communication network 120, e.g., through File Transfer Protocol (FTP), SSH File Transfer Protocol (SFTP), HyperText Transfer Protocol (HTTP), an Application Programming Interface (“API”), or any other communications protocol.

Server device 130 is communicatively coupled to database 140. Database 140 may be implemented by any type of storage, including volatile and non-volatile storage. Examples of database 140 include, without limitation, random access memory (RAM), read-only memory (ROM), and one or more disks. Database 140 may be external to server device 130, as shown in example network arrangement 100, or may be implemented as an internal component of server device 130. Furthermore, database 140 may communicate with server device 130 via communication network 120. Database 140 stores information used by IITM 135, e.g., aliases 141, permissions 142, accounts 143, messages 144, etc.

### Identity-Indicating Term Masker Functions

FIG. 2 illustrates an exemplary GUI 200 that includes a form 210 for entering user information that will be used for a hypothetical online community for couples. A user enters his real name 230 and an alias 240 for himself as well as his partner's real name 250 and an alias 260 for the partner and then submits the form 220 by activating the submit button 270. In one embodiment of the invention, the real name/alias pairs (real name 230/alias 240 and real name 250/alias 260) are stored in database 140 (FIG. 1) associated with the user and the user's partner.

IITM 135 may automatically grant to a user, who is designated as a particular user's partner (“partner user”), access privileges that are not given by default to other users. For example, in the account of the particular user, the default settings for other users is that identity-indicating information in a posted message is masked when the users view the message, and the users have no access to the particular user's account data, such as alias data or relationship data. In contrast, IITM 135 may grant to the partner user of the particular user the same rights as the particular user with respect to the particular user's account, including viewing and editing all account information. In fact, the partner user may not have a user account distinct from the particular user's account. Furthermore, the partner user may be granted fewer privileges than the particular user with respect to the particular user's account. For example the particular user may automatically be allowed to view identity-indicating information in the particular user's messages and may be allowed to edit alias data and only view relationship data for the particular user's account. In other embodiments of the invention, the partner user has a distinct account that may be associated with the particular user's account. Other default settings may be used within the embodiments of the invention. In various embodiments of the invention, a user need not have a partner user.

Alias data, including real name/alias pairs may be associated with only one user on the system, or combined with others. In one embodiment of the invention, a user may share alias data with the user's partner, and both users manage the shared alias data. For example, both the user and the partner user may view and edit the alias data shared between them, and masking for messages from both the user and the partner user is performed based on the shared alias data. In this embodiment, when a user adds a real name/alias mapping to the shared alias data or removes a mapping from the shared alias data, the modified alias data is applied to messages from both the user and the partner user. In another embodiment of the invention, partners have separate alias data. In yet another embodiment of the invention, partners have the option of sharing a shared set of alias data and using separate respective sets of personal alias data. Sharing of alias data may be accomplished via invitation. For example, a user may invite her partner to share her alias data, and the alias data would be considered shared after the partner accepts the invitation to share.

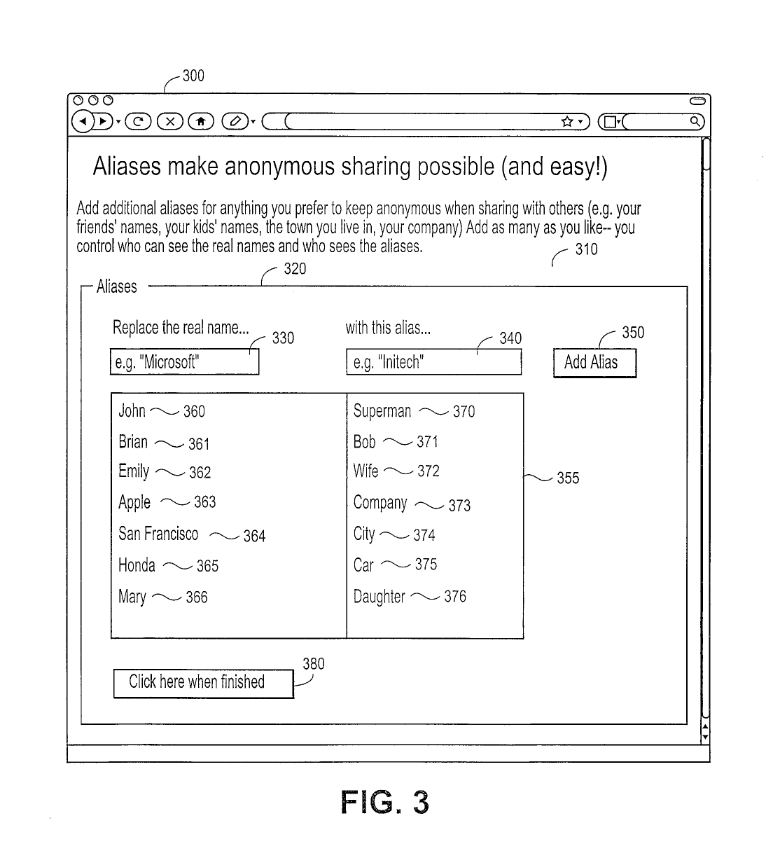

As illustrated in GUI 300 of FIG. 3, a user may enter additional real name/alias pairs in a form 320, e.g., contained in an online document 310. Upon activating an add alias button 350, the additional real name/alias pair indicated in text input 330 (real name) and text input 340 (alias) is stored in database 140 in association with the user's account. GUI 300 may display a list 355 of real name/alias pairs in alias data for the user's account, which list 355 includes real names 360-366 and aliases 370-376. Real names 360-366 are examples of identity-indicating information and aliases 370-376 are examples of aliases furnished by a user. When the user is finished adding real name/alias pairs, the user may activate button 380.

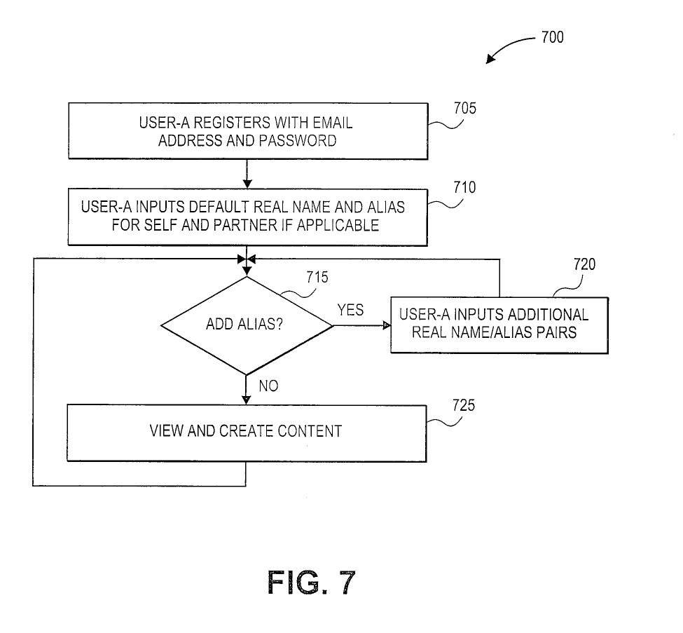

FIG. 7 illustrates a process flow 700 for associating real name/alias pairs to a user account. In step 705, USER-A registers an email address and a password with IITM 135. In step 710, USER-A inputs a default real name and alias for self and partner (if applicable). In step 715, it is determined whether USER-A will add one or more aliases to the user's alias data. For example, IITM client 114 receives a request from USER-A to add an alias to database 140 for a particular real name in a message. Other ways of determining whether a user will add an alias to the user's alias data are described in further detail below. In step 720, it is determined that USER-A will add an alias to the user's alias data, and USER-A inputs one or more additional real name/alias pairs. The one or more additional real name/alias pairs input by USER-A are stored at database 140. In step 725, it is determined that USER-A will not add to the user's alias data, and USER-A proceeds to view and create message content. For example, USER-A may view messages from other users in the online community and/or may draft a message to post in the online community.

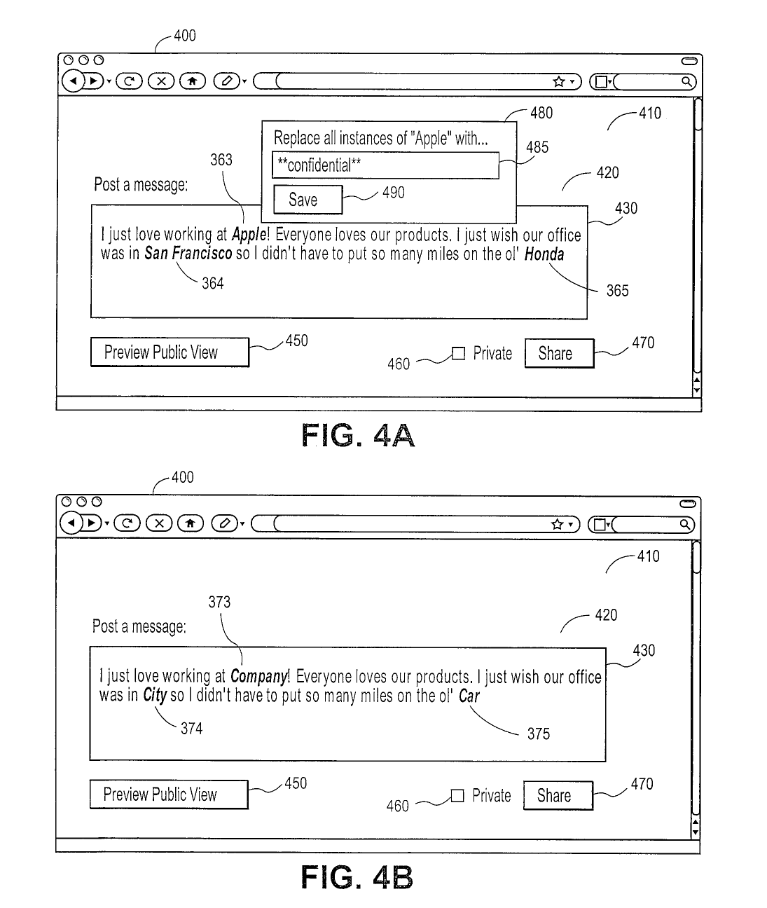

It is desirable for a user to be able to create real name/alias pairs quickly while creating messages. FIG. 4A and FIG. 4B illustrate an exemplary GUI 400 that contains a form 420 with an input text area 430, which allows a user to create a message, preview a public view of the message, and add real name/alias pairs based on terms in the message.

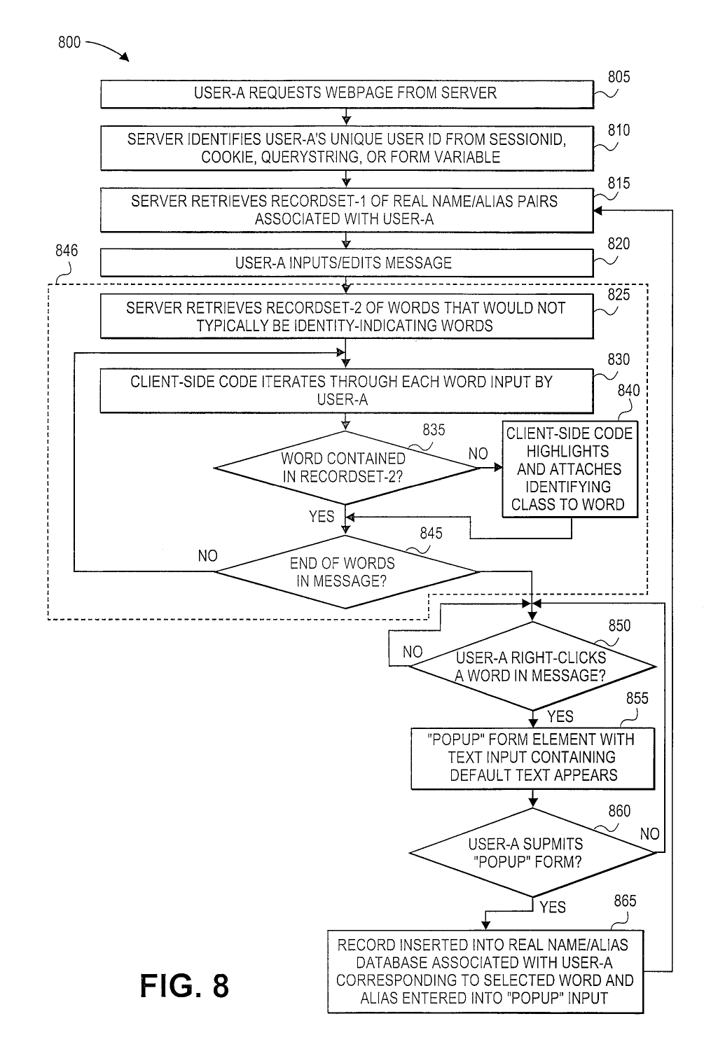

The flow chart in FIG. 8 describes a process 800 for creating and posting a message according to an embodiment of the invention, creating real name/alias pairs based on terms in the message, and previewing the public view of the message prior to posting. Thus, process 800 allows USER-A to enter a message, check for any identity-indicating information, and quickly add real name/alias pairs.

In step 805, USER-A requests a web page from the server, i.e., IITM 135. In step 810, the server (IITM 135) identifies USER-A's unique user id from sessionID, cookie, queryString, or form variable. In step 815, the server (IITM 135) retrieves RECORDSET-1 from database 140 (FIG. 1) containing real name/alias pairs that are associated with USER-A's account. In step 820, USER-A inputs a message into input text area 430 of FIG. 4.

The block labeled 846 illustrates one embodiment of the invention that adds real name/alias pairs to USER-A's alias data by highlighting likely identity-indicating terms in a message that USER-A is typing. This process starts with step 825, where the server (IITM 135) retrieves RECORDSET-2 containing words that are not typically identity-indicating words. For example, these words may come from a standard dictionary and would exclude proper nouns, names, places, etc. In step 830, IITM client 114 iterates through each word input as USER-A types the message into input text area 430.

In step 835, it is determined whether a particular word from input text area 430 is contained in RECORDSET-2. If the word is not contained in RECORDSET-2, then at step 840, IITM client 114 attaches an identifying class to the word, causing the word to appear visually highlighted from the other words. IITM client 114 also triggers an on-click behavior to open a “pop-up” dialog window 480 if USER-A chooses to click on the highlighted word. If it is determined that the word is contained in RECORDSET-2, or after step 840, at step 845 it is determined whether it is the end of words in the message. If it is not the end of words in the message, process 800 returns to step 830. If it is the end of words in the message, process 800 continues to step 850 described in further detail below. In another embodiment of the invention, IITM 135 retrieves a set of words from database 140 that are likely to be identity-indicating information and IITM client 114 highlights a word in input text area 430 if the word is included in the set of words.

GUI 400 of FIG. 4A illustrates several words that have been highlighted according to embodiments of the invention. In GUI 400, the words “Apple” 363, “San Francisco” 364, and “Honda” 365 are highlighted after USER-A finishes typing because they are not contained in a RECORDSET-2 and thus appear to be identity-indicating terms. In this example, RECORDSET-2 includes terms that are not likely to be identity-indicating.

Returning to process 800 at step 850, if USER-A chooses to right-click on a highlighted word contained in input text area 430, then at step 855 a pop-up dialog window 480 with a text input 485 appears. Text input 485 may contain default text for an alias and is editable by USER-A. Default text for such highlighted words may be specified by USER-A or USER-A's partner prior to inputting the message, or may be set in any other manner.

At step 860, it is determined whether USER-A submits the “popup” form. For example, USER-A submits the “popup” form illustrated by pop-up dialog window 480 of FIG. 4 when USER-A activates save button 490. If USER-A submits the “popup” form, then at step 865, a record with the real name/alias pair associating the selected highlighted word with the text in the text input 485 is inserted into the alias data for USER-A in database 140. For example, if USER-A activates save button 490 in the example GUI 400, then the text in text input 485 (“**confidential**”) is submitted to database 140 as the alias corresponding to “Apple” 363. If USER-A does not submit the “popup” form at step 860, process 800 returns to step 850.

Before submitting the message in input text area 430, USER-A may also view a public preview of the message by activating preview public view button 450 in GUI 400 of FIG. 4A. As illustrated in FIG. 4B, a request to preview the public view of a message may cause the text in input text area 430 to change to reflect what another user without permission to view identity-indicating information would see. The public preview of a message may be displayed to a user via any display mechanism, including one or more pop-up windows, a separate browser window, in an email sent to the user, etc.

To create a public preview of a message, IITM 135 may iterate through each word in the message to replace each instance of a real name, which is associated with an alias in the alias data for the user that authored the message, with the corresponding alias. To illustrate in the context of FIG. 4B, the real name “Apple” 363 is replaced with the alias “Company” 373, the real name “San Francisco” 364 is replaced with the alias “City” 374, and the real name “Honda” 365 is replaced with the alias “Car” 375. These are real name/alias pairs that are stored in database 140 in alias data associated with USER-A and/or USER-A's partner, depending on the implementation. Alternatively, USER-A may check the box labeled “Private” 460 to prevent any other user, who does not have permission from USER-A, from viewing the message. A user may share or publish the message in the online community, e.g., by activating share button 470. Activating preview public view button 451 returns the user to GUI 400 of FIG. 4A.

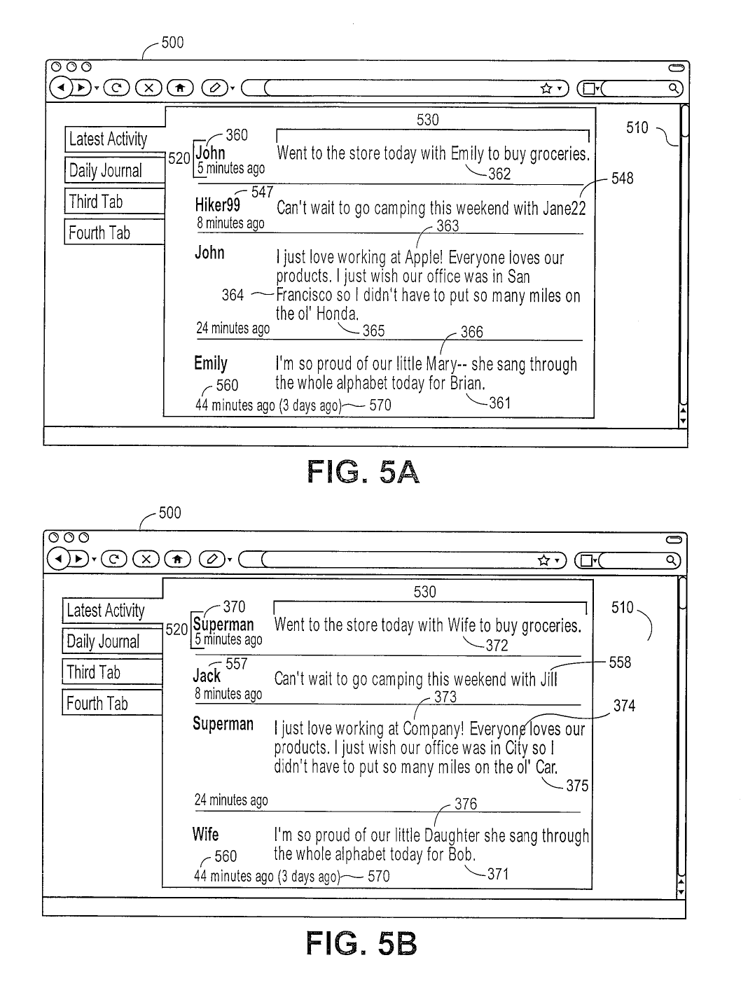

FIG. 5A and FIG. 5B illustrate an exemplary web page 500 with a GUI 510. As previously indicated, IITM client 114 could alternatively display GUI 510 in a stand-alone application, or using any other display mechanism. GUI 510 lists message posts, including message post 520, in reverse chronological order by creation date. Each post may include a message text 530, the message author, the time the message was created 560, as well as the date 570 to which the message applies, which may or may not be the same date that the message is created. If the applicable date is not the same as the creation date, the applicable date 570 is displayed in parenthesis next to the time the message was created 560.

FIG. 5A illustrates the view of a particular list of messages for a fictitious couple “John & Emily”, while FIG. 5B illustrates the view of the particular list of messages for a second fictitious couple “Jack & Jill”. In the examples of FIGS. 5A and 5B, John and Emily have not granted permission to view their identity-indicating information to Jack and Jill and vice versa. In FIG. 5A, in messages posted by John or Emily, IITM client 114 displays the following real names (without replacing the real names with corresponding aliases since John and Emily have rights to view identity-indicating terms in these messages): “John” 360, “Emily” 362, “Apple” 363, “San Francisco” 364, “Honda” 365, “Mary” 366, and “Brian” 361. In the message posted by Jack, IITM client 114 recognizes the following words as real names associated with aliases in Jack's alias data and masks the real names with corresponding aliases (since neither John nor Emily have rights to view Jack's identity-indicating information): “Hiker99” 547, and “Jane22” 548.

Conversely, in FIG. 5B in the message posted by Jack, IITM client 114 displays the following real names (without replacing the real names with corresponding aliases since Jack and Jill have rights to view identity-indicating terms in these messages): “Jack” 557 and “Jill” 558. In messages posted by John or Emily, IITM client 114 recognizes the following words as real names associated with aliases in John's and/or Emily's alias data and masks the real names with corresponding aliases (since neither Jack nor Jill have rights to view John's or Emily's identity-indicating information): “Superman” 370, “Wife” 372, “Company” 373, “City” 374, “Car” 375, “Daughter” 376, and “Bob” 371.

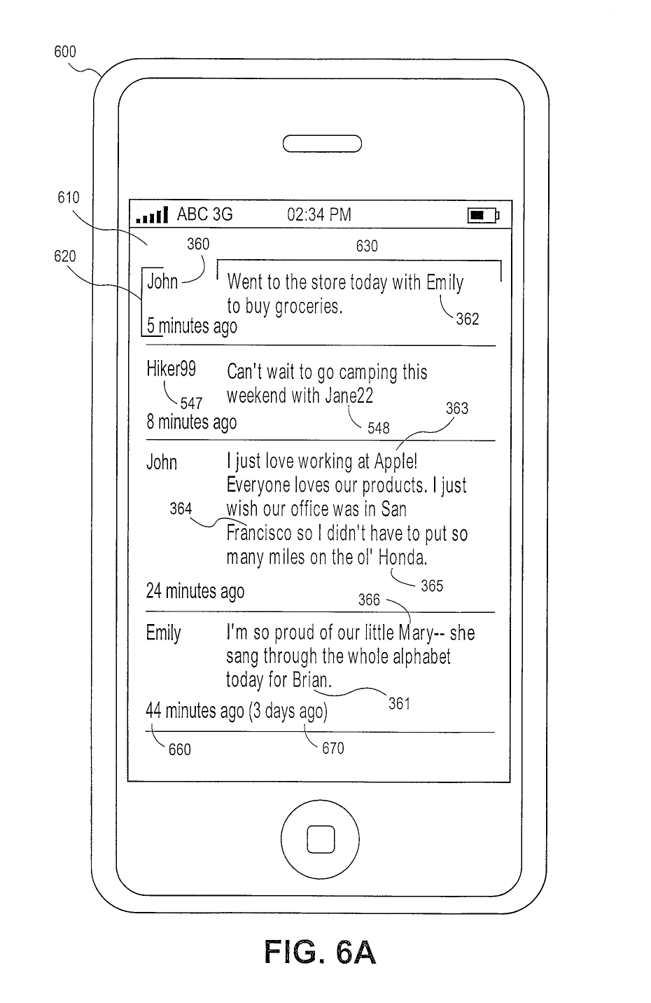

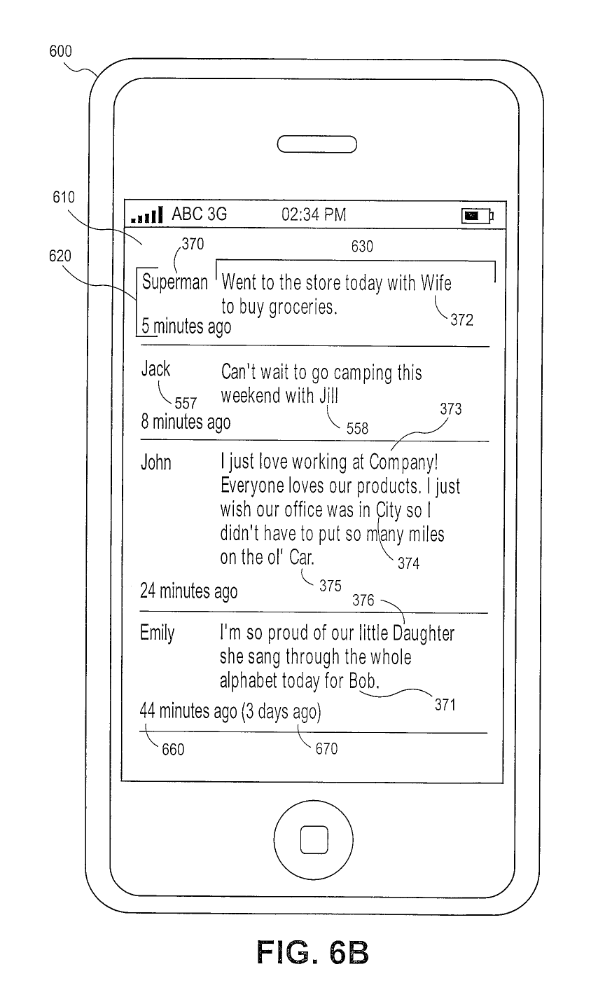

Similarly, FIG. 6A and FIG. 6B illustrate an exemplary mobile application 600 with functionality similar to that of exemplary web page 500. In one embodiment of the invention, a mobile version of IITM client 114 may include less functionality than a non-mobile version of IITM client 114. The functionality taken from a mobile version of IITM client 114 may be shifted to IITM 135 to reduce the computing requirements on a mobile device.

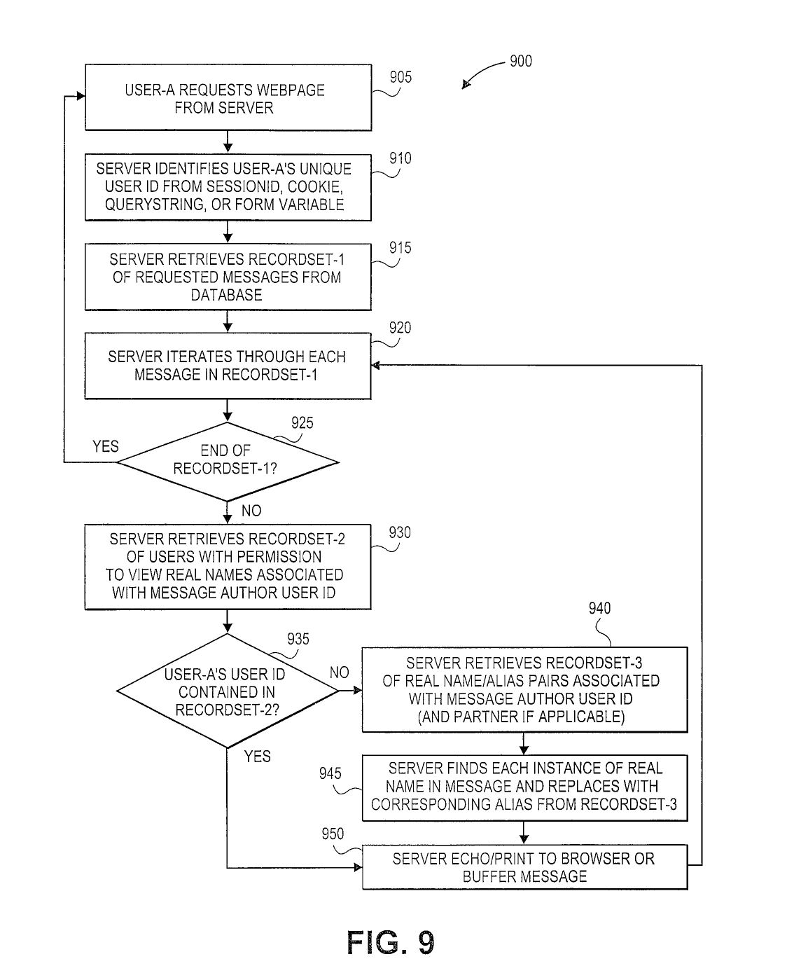

The process 900 of FIG. 9 illustrates an embodiment of the invention automatically replacing identity-indicating words in displayed user-generated messages based on corresponding users' alias data, as shown in FIG. 5A, FIG. 5B, FIG. 6A, and FIG. 6B. In step 905, USER-A requests a web page from a server, i.e., IITM 135. In step 910, IITM 135 identifies USER-A's unique user id from sessionID, cookie, queryString, or form variable. At step 915, IITM 135 retrieves RECORDSET-1 of requested messages from database 140. In step 920, IITM 135 iterates through each message in RECORDSET-1.

At step 925, it is determined whether it is the end of RECORDSET-1, i.e., IITM 135 determines that it has already iterated through each message in RECORDSET-1. If it is not the end of RECORDSET-1, then at step 930, IITM 135 retrieves RECORDSET-2, which contains a list of users with permission to view the real names associated with the message author's user ID. In another embodiment of the invention, RECORDSET-2 contains a list of users with permission to view the real names, or identity-indicating terms, associated with a particular message.

At step 935, it is determined whether USER-A's user ID is contained in RECORDSET-2. If USER-A's user ID is contained in RECORDSET-2, then at step 950, the message is displayed to USER-A, e.g., by IITM 135 activating server echo/print to browser or buffer message. If USER-A's user ID is not contained in RECORDSET-2, then at step 940 IITM 135 retrieves RECORDSET-3 of real name/alias pairs (alias data) associated with the message author's user id (and partner if applicable). In step 945, IITM 135 finds each instance in the message of a real name listed in RECORDSET-3 and replaces the real name with the corresponding alias from RECORDSET-3. Then, in step 950, the altered message is displayed to USER-A. From step 950, process 900 continues to step 920, in which IITM 135 continues to iterate through each message in RECORDSET-1 until the end of records for RECORDSET-1.

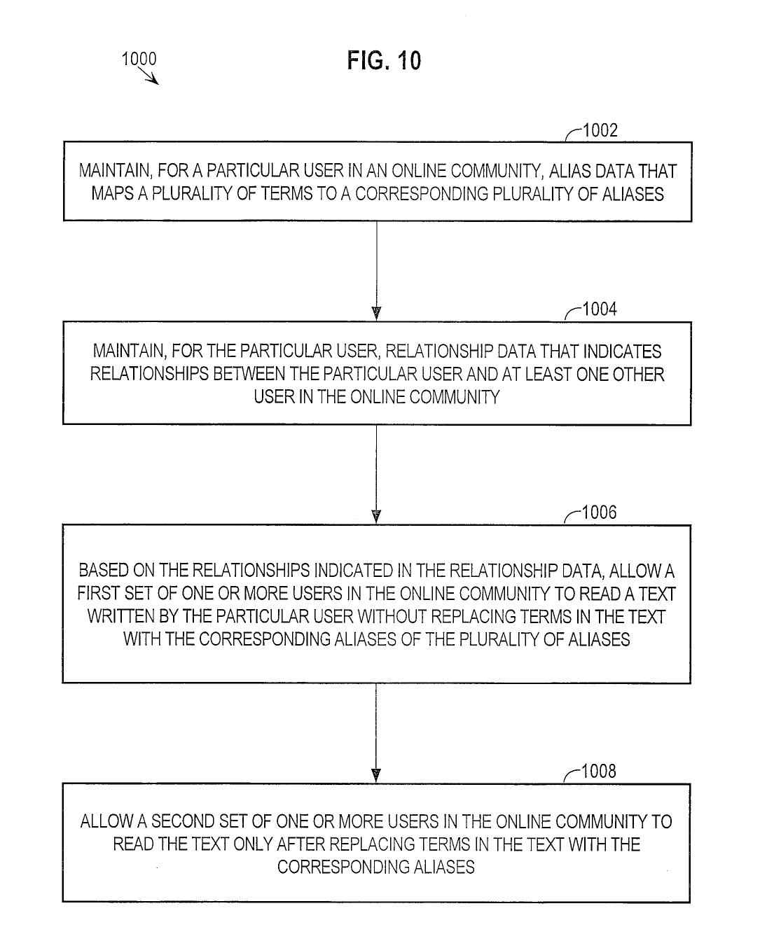

FIG. 10 illustrates a process 1000 for selectively masking identity-indicating information in user messages. At step 1002, alias data that maps a plurality of terms to a corresponding plurality of aliases is maintained for a particular user in an online community. For example, IITM 135 maintains, at database 140, alias data for a particular user (“USER-A”) of client computing device 105. In this example, the alias data maps real names 360-366 to aliases 370-376 (FIG. 3). This alias data is associated with information for USER-A, and may also be associated with information for a partner of USER-A. IITM 135 uses the alias data for USER-A to selectively mask identity-indicating information in messages posted by USER-A in connection with an online community.

At step 1004, relationship data that indicates relationships between the particular user and at least one other user in the online community is maintained for the particular user. For example, IITM 135 maintains, in database 140, relationship data for USER-A that indicates a set of users that are allowed to view USER-A's identity-indicating information. In this example, the relationship data indicates that USER-A has a partner (“USER-A1”) who is allowed to view USER-A's identity-indicating information, and that USER-A also allows a third user (“USER_B”) to view USER-A's identity-indicating information. In another embodiment of the invention, the relationship data includes users that are not allowed to view USER-A's identity-indicating information. A user's partner may be allowed to view the user's identity-indicating information by default.

At step 1006, a first set of one or more users in the online community is allowed to read a text written by the particular user without replacing terms in the text with the corresponding aliases of the plurality of aliases based on the relationships indicated in the relationship data. For example, when USER-A posts a message that contains identity-indicating information, USER-A1 and USER-B, who are identified in USER-A's relationship data, may view the identity-indicating information when they view the message.

To illustrate, USER-A1 at client computing device 105 requests web page 500 (FIG. 5A) from server device 130. Prior to sending web page 500 to client computing device 105, IITM 135 determines that web page 500 includes a message from USER-A and checks the relationship information associated with USER-A, stored at database 140, to determine whether USER-A1 has permission to view USER-A's identity-indicating information. In response to determining that USER-A1 has permission, IITM 135 sends web page 500, with a version of USER-A's message that contains identity-indicating information, to client computing device 105. Web page 500 is interpreted for viewing by browser application 113 on client computing device 105. In the example of web page 500, USER-A's name is “John” and USER-A1's name is “Emily”. USER-A1 can see all of the identity-indicating information in messages from USER-A because USER-A1 has permission to do so based on USER-A's relationship information.

At step 1008, a second set of one or more users in the online community is allowed to read the text only after replacing terms in the text with the corresponding aliases. For example, USER-C, on client computing device 105, requests web page 500 from server 130. Prior to sending web page 500 to client computing device 105, IITM 135 determines that web page 500 includes a message from USER-A and checks the relationship information associated with USER-A to determine whether USER-C has permission to view USER-A's identity-indicating information. According to the above example, USER-C does not have permission to view USER-A's identity-indicating information.

In one embodiment of the invention, in response to determining that USER-C does not have permission, IITM 135 creates a modified version of the message from USER-A by replacing terms in the text of the message with aliases corresponding to the terms, as indicated by the alias data in database 140 associated with USER-A. To illustrate, FIG. 4A shows a message with identity-indicating information and FIG. 4B shows the same message that has been modified by replacing identity-indicating terms in the message with aliases. Furthermore, IITM 135 may identify terms in the message from USER-A that are likely to be identity-indicating, but that are not mapped to aliases in the alias data for USER-A. In this case, IITM 135 may automatically replace the likely identity-indicating terms with default text that masks the terms. Such automatic replacement of likely identity-indicating terms in a user's messages may be performed based on user preferences, authorizing the automatic replacement, stored for a user at database 140.

IITM 135 may notify USER-A of the automatic masking of terms in USER-A's message and USER-A may be given the opportunity to specify an alias for the terms, or to instruct IITM 135 that the terms are not identity-indicating. IITM 135 may place terms that USER-A indicates are not identity-indicating in a list of non-identity-indicating terms (“blackout list”), which is specific to USER-A. IITM 135 also may place such terms in a blackout list for all users of an online community, or for a subset of those users. Placing non-identity-indicating terms in a universal list may be based on established criteria, such as at least a threshold number of users have indicated that a particular term is not identity-indicating.

In another embodiment of the invention, prior to receiving any request for a particular message from USER-A, IITM 135 creates a modified version of the particular message by replacing terms in the message with aliases corresponding to the terms, as indicated by the alias data in database 140 associated with USER-A. Thus, when USER-C (who does not have permission to view USER-A's identity-indicating information) requests the message, the modified version is already prepared and is included in the web page sent to USER-C.

IITM 135 sends web page 500 with the modified version of USER-A's message to client computing device 105 and the web page is interpreted for viewing by browser application 113. Use of the web page construct in these examples is illustrative and is not meant to limit the scope of the embodiments of the invention.

The type of relationship defined between two users may be different in the relationship data for each of the users. For example, the relationship data for USER-A may indicate that USER-B is permitted to view USER-A's identity-indicating information. In contrast, the relationship data for USER-B may indicate that USER-A is not permitted to view USER-B's identity-indicating information. Such a situation may occur if USER-A is a client of USER-B, who is a marriage counselor.

In another embodiment of the invention, relationships are mutually identified, i.e., relationships must be verified by both parties of the relationship. For example, after USER-A grants USER-B permission to view USER-A's identity-indicating information, USER-B must confirm that USER-B wishes to see USER-A's identity-indicating information prior to being permitted to view USER-A's identity-indicating information. In yet another embodiment of the invention, USER-A and USER-B always have the same permissions with respect to viewing the other's identity-indicating information.

### Creating Alias Data

A user may create alias data by explicitly identifying real name/alias mappings for IITM 135 as illustrated by GUI 300 of FIG. 3. Furthermore, a user may create alias data while creating a message for an online community as illustrated by GUI 400 of FIG. 4A. In one embodiment of the invention, a user may identify a term, in the message, with which the user would like to associate an alias, e.g., by clicking on the term, highlighting the term, otherwise moving a cursor to the term, activating a button on a GUI, etc. In response to the identification, IITM client 114 receives the alias data, e.g., through pop-up dialog window 480. When the user activates save button 490, IITM client 114 causes the new real name/alias mapping to be stored in alias data for the user at database 140. Pop-up dialog window 480 may also include a cancel button to allow the user to eliminate pop-up dialog window 480 without creating a new real name/alias mapping.

In one embodiment of the invention, IITM client 114 automatically generates a visual indication that identifies a likely identity-indicating term in a message being created by a user. Such a visual indication may be highlighting, font changes, or any other visual method of indicating a particular term. IITM client 114 may determine a likely identity-indicating term by comparing each term in the message with a list of terms that are not identity-indicating, and/or with a list of terms that are likely to be identity-indicating. A list of terms that are likely to be identity-indicating may be compiled based on the alias data of other users. For example, if alias data stored by IITM 135 maps a particular term to aliases, then the particular term is likely to be identity-indicating. IITM 135 may determine that a particular term is likely to be identity-indicating if more than a threshold number of users map the term to an alias in the users' alias data. IITM 135 may also use a dictionary or other source of words to compile the list. Such a list may be of words that are likely to be identity-indicating and/or of words that are likely to not be identity-indicating.

Once IITM client 114 has visually indicated one or more terms that are likely to be identity-indicating, a user may activate a control that allows the user to specify an alias for such a term. For example, pop-up dialog window 480 may appear in response to a user clicking on a term that has been identified by IITM client 114 as likely to be identity-indicating. Through pop-up dialog window 480, a user may map an alias to the term and cause IITM 135 to store the new real name/alias pair in database 140.

IITM client 114 may also visually indicate terms in a message being created by a user that are mapped to aliases in the alias data for the particular user. Such a visual indication may be different than the visual indication of likely identity-indicating terms.

Different users may create different aliases for the same identity-indicating term (or “real name”). For example, USER-A may store, as part of USER-A's alias data in database 140, a mapping between the term “John” and the alias “Handy Man”. USER-B may store, as part of USER-B's alias data in database 140, a mapping between the term “John” and the alias “my son”. In an alias-masked message from USER-A, the term “John” will be replaced by “Handy Man”, and in an alias-masked message from USER-B, the term “John” will be replaced by “my son”, according to the alias data for the respective users.

### Selective Masking Preview

Prior to publishing a message to be read by users in an online community, a user may preview an alias-masked version of the message with the identity-indicating information replaced with aliases. For example, in response to a user activating preview public view button 450 (FIG. 4A), IITM client 114 obtains the alias data for the user from database 140 and uses the alias data to create an alias-masked message in which real names are replaced with aliases. An example of an alias-masked message is illustrated in FIG. 4B. The message in FIG. 4B corresponds to the message in FIG. 4A, but with all of the real names replaced by aliases.

IITM client 114 may visually distinguish the aliases in the modified preview message, e.g., by highlighting, changing the font, or by another visual mechanism. In one embodiment of the invention, a user may select an alias in the modified preview message and update alias data for the alias. For example, the user may edit or remove a selected alias. Furthermore, a user may select a term in the modified preview message that has no associated alias, and as a result of the selection, IITM client 114 allows the user to add an alias for the term to the alias data associated with the user in database 140. For example, in response to a user selecting a term in an alias-masked message that is not an alias, IITM client 114 provides a pop-up dialog window in which a user may enter an alias. Furthermore, IITM client 114 may visually indicate terms in the alias-masked message that are likely to be identity-indicating. The user may or may not choose to provide IITM client 114 with aliases for such likely identity-indicating terms.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 11 is a block diagram that illustrates a computer system 1100 upon which an embodiment of the invention may be implemented. Computer system 1100 includes a bus 1102 or other communication mechanism for communicating information, and a hardware processor 1104 coupled with bus 1102 for processing information. Hardware processor 1104 may be, for example, a general purpose microprocessor.

Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, such as a magnetic disk or optical disk, is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1110. Volatile media includes dynamic memory, such as main memory 1106. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
maintaining, for a particular user in an online community, alias data that maps a plurality of terms to a corresponding plurality of aliases;
maintaining, for the particular user, relationship data that indicates relationships between the particular user and at least one other user in the online community;
based on the relationships indicated in the relationship data, allowing a first set of one or more users in the online community to read a text written by the particular user without replacing terms in the text with the corresponding aliases of the plurality of aliases;
allowing a second set of one or more users in the online community to read the text only after replacing terms in the text with the corresponding aliases;
wherein the method is performed by one or more computing devices.

2. The method of claim 1 wherein allowing the second set of one or more users to read the text comprises:
receiving a request, from a first user that belongs to the second set of one or more users, for the text;
in response to the request, reading the relationship data of the particular user to determine that the first user belongs to the second set of one or more users;
in response to determining that the first user belongs to the second set of one or more users, creating a modified version of the text by replacing terms in the text with the corresponding aliases; and
providing the modified version of the text in response to the request.

3. The method of claim 1 wherein allowing the second set of one or more users to read the text comprises:
prior to receiving any request, from a first user that belongs to the second set of one or more users, for the text, creating a modified version of the text by replacing terms in the text with the corresponding aliases;
in response to a request from the first user for the text, reading the relationship data of the particular user to determine that the first user belongs to the second set of one or more users;
in response to determining that the first user belongs to the second set of one or more users, providing the modified version of the text in response to the request.

4. The method of claim 1 further comprising:
as the particular user writes the text, automatically generating a visual indication when terms written by the particular user do not match any words in a particular set of words;
in response to user input that selects a term for which the visual indication was generated, displaying a user interface that includes controls that allow the particular user to specify an alias for the selected term; and
in response to the particular user specifying the alias for the selected term, updating the alias data to establish association between the alias and the selected term.

5. The method of claim 1 wherein:
the particular user is a first user and the alias data of the first user is first alias data;
the online community includes a second user;
the method further comprises maintaining, for the second user, second alias data that maps a second plurality of terms to a corresponding second plurality of aliases;
the first alias data maps a particular term to a first alias; and
the second alias data maps the particular term to a second alias that is different from the first alias.

6. The method of claim 1 wherein:
the particular user is a first user and the relationship data of the first user is first relationship data;
the online community includes a second user;
the method further comprises maintaining, for the second user, second relationship data that indicates relationships between the second user and at least one other user in the online community;
the first relationship data indicates a first type of relationship between the first user and the second user; and
the second relationship data indicates a second type of relationship between the second user and the first user, wherein the second type of relationship is different from the first type of relationship.

7. The method of claim 1 further comprising:
prior to allowing any user in the second set of one or more users to read the text, identifying one or more identity-indicating terms in the text for which the alias data does not specify aliases; and
automatically replacing the one or more identity-indicating terms with a default alias value.

8. The method of claim 7 further comprising evaluating the text against a database of words, to determine which terms in the text qualify as identity-indicating terms.

9. The method of claim 7 further comprising evaluating the text based, at least in part, on a list of real names identified by users in the online community, to determine which terms in the text qualify as identity-indicating terms.

10. The method of claim 1 further comprising providing a mechanism by which the particular user can preview the text, with terms in the text automatically replaced with the corresponding aliases, prior to submitting the text to be read by users in the online community.

11. The method of claim 1 further comprising:
storing data that indicates a particular set of users, in the online community, that share the alias data used by the particular user;
enabling users, in the particular set of users, to add or edit term/alias combinations specified in the alias data; and
when a term in a text written by any user in the particular set of users matches a term in a term/alias combination that is contained in the alias data, modifying the text by causing the term to be replaced with the corresponding alias, prior to allowing a user that is not in the second set of one or more users to read the text.

12. A non-transitory computer-readable storage storing instructions which, when executed by one or more processors, cause performance of the method of any one of claim 1-11.

13. A system comprising one or more processors, memory coupled to the one or more processors, and instructions stored in the memory, wherein the instructions are instructions for performing the method recited in any one of claim 1-11.
